(19) United States
(12) Patent Application Publication
(10) Pub. No.: US 2024/0417108 A1
(43) Pub. Date: Dec. 19, 2024

(54) SATELLITE OPERATION AND PROCESSING OF SATELLITE STATE DATA

(71) Applicant: ICEYE OY, Espoo (FI)

(72) Inventors: Alastair Barber, Espoo (FI); Melina Koukou, Espoo (FI)

(73) Assignee: ICEYE OY, Espoo (FI)

(21) Appl. No.: 18/701,704

(22) PCT Filed: Oct. 14, 2022
(86) PCT No.: PCT/EP2022/078733

§ 371 Date: Apr. 16, 2024

(30) Foreign Application Priority Data
Oct. 29, 2021 (GB) 2115622.9

(51) Int. Cl. B64G 1/24

(52) U.S. Cl. CPC B64G 1/242

(57) ABSTRACT

There are provided methods of processing satellite state data, comprising receiving satellite state data in the form of multiple separate files via one or more ground stations and compiling the received satellite state data into a single dataset accessible via an application programming interface and searchable by time range. There are further provided methods of processing satellite state data comprising receiving raw satellite state data; receiving manoeuvre data relating to one or more scheduled manoeuvres of the satellite; and filtering the received raw satellite state data in an orbit determination process to provide filtered satellite state data, wherein the manoeuvre data is used in the filtering of the received raw satellite state data. There are further provided methods of scheduling a satellite manoeuvre comprising: receiving parameters for one or more planned manoeuvres to move the satellite from a current orbit to a new orbit, wherein the parameters include a time and duration of each of the one or more planned manoeuvres; receiving times of eclipses of the Sun by the Earth during future orbits of the satellite; and scheduling the manoeuvre to take place according to the determined parameters and the times of eclipses.

The invention is in the field of satellite operation.

### BACKGROUND

In the field of Synthetic Aperture Radar (SAR) imaging, particularly but not exclusively using small satellites, an essential process for accurate planning, acquisition and processing of images is Orbit Determination (OD) for the satellite in question.

A process of OD may result in accurate historical values for the satellite's position and velocity, as well as predicted values for the future. OD is well known in the art of satellite operation and may generally be described as a filtering method to integrate observation and orbit dynamic equations to estimate the position and velocity of a satellite. In other words, the state variables (position and velocity) of a satellite are estimated based on observed measurement data or “raw” data and the orbit dynamic equations which form a dynamic model of the movements of the satellite. An OD process tool is commonly referred to as a filter and the output is referred to as filtered data.

To achieve OD, satellites can use on-board Global Navigation Satellite Systems (GNSS) receivers to regularly take measurements for position, velocity and time (ephemerides' state vectors), and these can be downlinked during a ‘pass’ over a ground-station antenna. Due to the nature of this system, these measurements can contain anomalies and are usually processed to achieve the desired accuracy, in what is known as a filtering process, using an OD tool. Such anomalies may arise, for example, due to a loss of telemetry data, invalid GPS indications (or other location indicators), or due to temporary damage to a GNSS receiver—this damage may be caused, for example, by solar radiation. OD tools exist which perform various algorithms to produce both filtered historical and predicted future orbit ephemerides.

Additionally, satellites may perform on-board filtering of parts of the measured raw state vector data. For example, on-board processing systems of the satellite may filter raw position data. This position data may be gathered through GPS measurements or another suitable means. This pre-filtered data then becomes a part of telemetry data that is downlinked to a ground-station antenna. This may lead to an uncertainty in the estimation of the state vectors by the ground-station antenna.

For some uses of SAR it is desirable to improve the accuracy of the placement, or positioning, of the satellite at particular times. This is especially important for the formation of images since the resolution depends on the accuracy of position of the satellite. For some satellite monitoring applications the ability to detect movements of less than a metre is being demanded.

It is also important for many applications to maintain the satellite in a particular orbit and therefore its position and/or state needs to be known in case it has drifted. Manoeuvres may be required at regular intervals in order to maintain the orbit. It may also be necessary to manoeuvre the satellite to avoid collision, for example with other satellites or debris. This may involve temporarily manoeuvring the satellite from its orbit or scheduling a manoeuvre to avoid a collision.

The manoeuvring of a satellite, for example to maintain a specific position and/or to avoid collision, is sometimes referred to as astrodynamics.

Some embodiments of the invention described below are directed to some of these problems. However the invention is not limited to solutions to these problems and some embodiments of the invention solve other problems.

### SUMMARY

This summary is provided to introduce a selection of concepts in a simplified form that are further described below in the detailed description. This summary is not intended to identify key features or essential features of the claimed subject matter, nor is it intended to be used to determine the scope of the claimed subject matter.

In a first aspect, there is provided a method of processing satellite state data, the method comprising: receiving satellite state data in the form of multiple separate files via one or more ground stations; and compiling the received satellite state data into a single dataset accessible via an application programming interface and searchable by time range.

In some embodiments, the satellite state data may comprise raw data.

In some embodiments, the method may further comprise: filtering the raw satellite state data in an orbit determination process to provide filtered satellite state data, wherein the filtering may be performed in parallel with the compiling of the received satellite state data, and wherein each item of filtered satellite state data may correspond to an item of raw satellite state data.

In some embodiments, the method may further comprise: receiving manoeuvre data relating to one or more scheduled manoeuvres of the satellite and compiling the received manoeuvre data into a dataset accessible via an application programming interface and searchable by time range.

In some embodiments, the manoeuvre data may be used in the filtering of the received raw satellite state data.

In another aspect, there is provided a method of processing satellite state data, the method comprising: receiving raw satellite state data; receiving manoeuvre data relating to one or more scheduled manoeuvres of the satellite; and filtering the received raw satellite state data in an orbit determination process to provide filtered satellite state data, wherein the manoeuvre data is used in the filtering of the received raw satellite state data.

In some embodiments, receiving the raw satellite state data may comprise: receiving the raw satellite state data in the form of multiple separate files via one or more ground stations; and wherein the method may further comprise: compiling the received raw satellite state data into a single dataset accessible via an application programming interface and searchable by time range.

In another aspect, there is provided a method of scheduling a satellite manoeuvre, the method comprising: receiving parameters for one or more planned manoeuvres to move the satellite from a current orbit to a new orbit, wherein the parameters include a time and duration of each of the one or more planned manoeuvres; receiving times of eclipses of the Sun by the Earth during future orbits of the satellite; and scheduling the manoeuvre to take place according to the determined parameters and the times of eclipses.

The aspects described herein may be combined, or features associated with one of the aspects may be implemented in one or more of the other aspects.

In some embodiments, the method may further comprise inserting the filtered satellite state data into the single dataset.

In some embodiments, inserting the filtered satellite state data into the single dataset may comprise: overwriting the raw satellite state data in the dataset with the corresponding filtered satellite state data.

In some embodiments, the filtered satellite state data may comprise historical satellite state data.

In some embodiments, the historical satellite state data may be real data associated with one or more historic state vectors of the satellite.

In some embodiments, the filtered satellite state data may comprise future satellite state data.

In some embodiments, the future satellite state data may be projected data based on a dynamic model configured to predict future state vectors of the satellite.

In some embodiments, the method may further comprise mapping metadata relating to the satellite to the satellite state data.

In some embodiments, the metadata may comprise one or more of: data associated with physical dimensions of the satellite; satellite attitude data; and/or satellite thrust data comprising information associated with historic and future planned manoeuvres of the satellite.

In some embodiments, the method may further comprise supplying the metadata for use in the filtering of the raw satellite state data.

In some embodiments, the received manoeuvre data may comprise one or more of: time of the manoeuvre; thrust duration; thrust magnitude; thrust direction; and/or thrust specific impulse for each of the one or more scheduled manoeuvres.

In some embodiments, the one or more scheduled manoeuvres may include one or more future scheduled manoeuvres of the satellite.

In some embodiments, the method may further comprise maintaining a dynamic model of the movement of the satellite wherein the data relating to the one or more future scheduled manoeuvres is used to update the dynamic model.

In some embodiments, estimates of the state of the satellite obtained from the dynamic model may be used in the filtering of the received raw satellite state data.

In some embodiments, estimates of the state of the satellite may include estimates of the position of the satellite.

In some embodiments, estimates of the satellite may include estimates of the velocity of the satellite.

In some embodiments, the method may further comprise: receiving confirmation that the satellite has been commanded to execute one of the one or more future scheduled manoeuvres.

In some embodiments, the one or more scheduled manoeuvres may include one or more historic manoeuvres.

In some embodiments, the manoeuvre data relating to the one or more historic manoeuvres of the satellite may comprise measurement data of one or more of: time of the manoeuvre, thrust duration, thrust magnitude, thrust direction, and/or thrust specific impulse for each of the one or more historic manoeuvres of the satellite.

In some embodiments, after a scheduled manoeuvre was scheduled to be executed, the measurement data may be used to determine whether the scheduled manoeuvre was executed.

In some embodiments, the method may further comprise: removing from the filtered satellite state data, data relating to a manoeuvre that was determined as having not been executed.

In some embodiments, the manoeuvre data may relate to manoeuvres over a period of time.

In some embodiments, receiving the manoeuvre data may involve receiving the manoeuvre data periodically.

In some embodiments, the received manoeuvre data may relate to contiguous time periods.

In some embodiments, the satellite state data may comprise satellite position data.

In some embodiments, the satellite state data may comprise satellite velocity data.

In some embodiments, the satellite state data may comprise ephemerides state vector data.

In some embodiments, the satellite state data may be received in a queue.

In some embodiments, the method may further comprise: copying satellite state data that has been received since a previous time interval into a working directory.

In some embodiments, the dataset may be stored in a relational database.

In some embodiments, the satellite state data may be received as files per pass of the satellite and the data in the dataset may be searchable over a time period including multiple passes.

In some embodiments, scheduling the satellite manoeuvre may further comprise: scheduling the time of the manoeuvre to avoid a proportion of the orbit during which the exposure of the satellite to the Sun is maximised.

In some embodiments, the proportion of the orbit to be avoided may be a quarter of the orbit.

In some embodiments, the duration of at least one of the planned manoeuvres may be a period including at least two orbits of the satellite around the Earth.

In some embodiments, the scheduled manoeuvre may comprise at least two sub-manoeuvres.

In some embodiments, each of the sub-manoeuvres may be scheduled to be executed during different orbits of the satellite.

In some embodiments, at least one of the planned manoeuvres may be a manoeuvre to return the satellite to a predetermined orbit.

In some embodiments, at least one of the planned manoeuvres may be a manoeuvre to avoid a collision.

In some embodiments, scheduling the satellite manoeuvre may further comprise: determining candidate parameters for one or more of the planned manoeuvres to move the satellite from a current orbit to a new orbit, wherein the parameters may include a candidate time and candidate duration of each of the one or more planned manoeuvres; supplying the candidate parameters to a collision avoidance system; receiving a respective probability of collision from the collision avoidance system based on each set of candidate parameters; if each of the probabilities of collision is above a predetermined threshold, determining new candidate parameters for the one or more planned manoeuvres; and repeating the operation of determining candidate parameters for each of the one or more planned manoeuvres until at least one of the respective probabilities of collision is below the predetermined threshold.

In some embodiments, scheduling the satellite manoeuvre may further comprise: receiving propulsion scheduling requirements; and scheduling the manoeuvre to take place according to the propulsion scheduling requirements.

In another aspect, there is provided a method of operating a satellite in which manoeuvres of the satellite are scheduled according to the methods described herein.

In another aspect, there is provided a method of operating a satellite propulsion system, the method comprising: commanding a manoeuvre of the satellite based on manoeuvre data relating to one of one or more future scheduled manoeuvres and based on an assumed relationship between the manoeuvre data relating to the commanded manoeuvre and a change in orbit of the satellite; receiving satellite state data associated with the orbit of the satellite after the execution of the commanded manoeuvre according to the command; and confirming or updating the assumed relationship based on the received satellite state data, wherein the orbit of the satellite is determined in an orbit determination process according to the methods described herein.

In another aspect, there is provided a method of processing SAR image data, the method comprising: receiving image data acquired during a timespan; receiving satellite state data processed according to the methods described herein, wherein the received satellite state data corresponds to a timespan associated with the received image data; using the received satellite state data to estimate or determined a geolocation error associated with a position estimate of the satellite; if the geolocation error is larger than a predetermined threshold, requesting satellite state data for a larger timespan and repeating the estimation of geolocation error; and only passing the image data to a stack for further processing if the geolocation error is below the predetermined threshold.

In another aspect, there is provided a data processing apparatus configured to perform the methods described herein.

In another aspect, there is provided a distributed computing system configured to perform the methods described herein.

In another aspect, there is provided a computer-readable medium comprising logic which, when executed by a computer, cause the computer to carry out the methods described herein.

In another aspect, there is provided a computer program comprising instructions which, when executed by a computer, cause the computer to carry out the methods described herein.

Some embodiments of the invention provide a system comprising one or more computing systems each comprising at least one processor and memory, the system being configured to implement any of the methods or processes described here.

Some embodiments of the invention also provide a computer readable medium comprising instructions, for example in the form of an algorithm, which, when implemented in a computing system forming part of a satellite operating system, cause the system to perform any of the methods or processes described here.

Features of different aspects and embodiments of the invention may be combined as appropriate, as would be apparent to a skilled person, and may be combined with any of the aspects of the invention.

### BRIEF DESCRIPTION OF THE DRAWINGS

Embodiments of the invention will be described, by way of example only and with reference to the following drawings, in which:

FIG. 1 is a schematic diagram of a system for controlling the operation of a satellite according to some embodiments of the invention;

FIG. 2 is a schematic diagram showing in more detail data exchanged between the OD server and OD process tool of FIG. 1;

FIG. 3 is a block diagram of a quality control process that may be incorporated into the system of FIG. 1;

FIG. 4 is a block diagram showing a collision avoidance process which may be implemented in the system of FIG. 1;

FIG. 5 is a block diagram showing operations that may be performed by an orbital simulator in the system of FIG. 1;

FIG. 6 is a block diagram of a process of manoeuvre planning;

FIG. 7 is a perspective view of a satellite in orbit around the earth;

FIG. 8 is a block diagram showing operations that may be performed by an image scheduler in the system of FIG. 1;

FIG. 9 is a block diagram showing operations that may be performed by a propulsion system calibrator in the system of FIG. 1.

Common reference numerals are used throughout the figures to indicate similar features.

### DETAILED DESCRIPTION

Embodiments of the present invention are described below by way of example only. These examples represent the best ways of putting the invention into practice that are currently known to the applicant although they are not the only ways in which this could be achieved.

### System Architecture

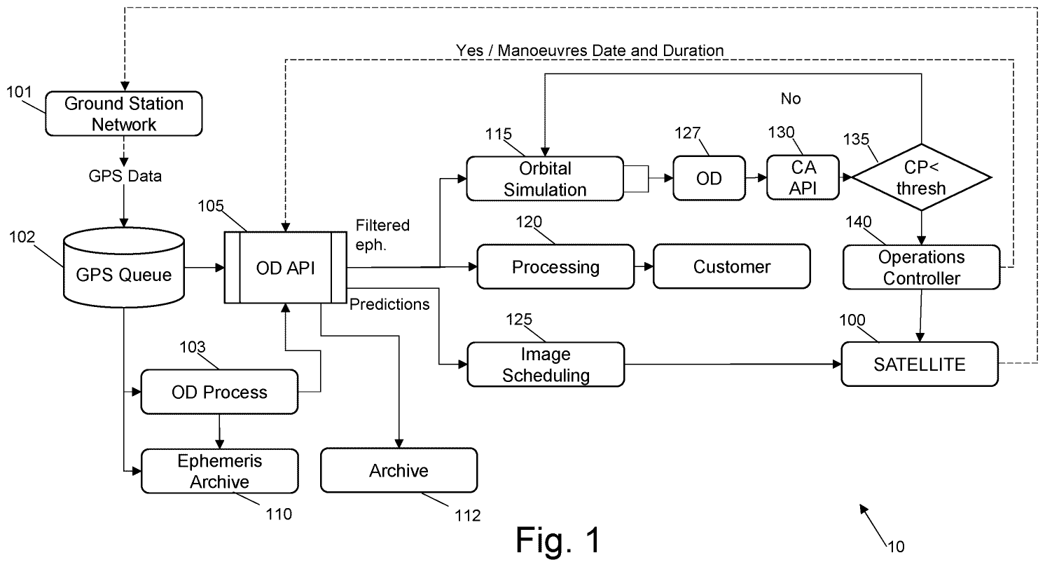

FIG. 1 illustrates a system 10 for controlling the operation of a satellite 100. The same system may be used to control the operation of multiple satellites, for example in a constellation otherwise known as a fleet. FIG. 1 will generally be described with reference to one satellite.

The system of FIG. 1 may be configured to implement one or more methods of processing satellite position data, and a method of operating a satellite propulsion control system described further in the following. Components of the system 10 may be distributed over multiple locations, for example but not necessarily different terrestrial locations.

The system 10 is configured to receive raw data. The raw data may consist of ephemerides state vectors, typically in binary form, for example transmitted from the satellite ADCS (attitude determination and control systems) unit. The state vectors may include satellite position data, in this example GPS data, which is held in a GPS queue 102. This is performed automatically and for every satellite 100 in a fleet. The GPS data, which originates from the satellite 100, may be routed to the system in a variety of different ways, for example from one or more ground stations in a ground station network 101 in communication with the satellite and with the system 10. The state vectors may further include satellite velocity data indicative of a speed and direction of travel of the satellite 100. The raw data is received in multiple separate files. In a specific example of operation of the system, the binary data is then parsed into a text-based format for use by an OD process tool 103, and the file containing the text-based data is placed in the ephemeris archive 110 or GPS queue 102.

It should be noted here by way of background that an orbit is defined by the six Orbital Parameters: 1. Semi major axis of the eclipse (this is describing the altitude), 2. Inclination, 3. Eccentricity of the eclipse, 4. Argument of Perigee (where the closest point to the earth is located on the orbit arc), 5. Longitude of ascending node, 6. True anomaly. An orbit can be also described by state vector (position, velocity and time) given that by estimating accelerations of the satellite, information about the orbit's state and energy can be derived.

In the following description, position data for the satellite is assumed to be GPS data. However other forms of data may be used in addition to or alternatively to GPS data and the systems, methods and processes described here are not limited to GPS data. Thus raw ephemerides state vectors are taken to be an example of position data.

The GPS data is transmitted from the GPS queue 102 to an orbit determination server 105 which includes an application programming interface “OD API”. Here GPS data received from the satellite, typically in individual files and sometimes received from different ground stations, is compiled into a dataset accessible via the API and searchable by time range. For this purpose the data may be organised in time sequential order. The data may then be searchable, for example via an http interface, so that it is more readily accessible and can for example be served outside the system 10 or for other purposes within the system 10. In response to a request via the API, the data may then be provided in a form such that recipients or requestors of the data do not require knowledge of the GPS data or satellite constellation data in order to be able to use it. This compiling of the data may be performed in various ways, and additional operations may be performed on the data. For example the OD sever 105 may receive the text-based file, further parse it and store the data in a dataset such as a relational database which can be searchable by, for example, time range and satellite. Other ways of compiling the received data files into a dataset will be familiar to those skilled in the art and the systems described here are not limited to the use of relational databases.

In the system of FIG. 1, the OD server 105 is configured to control an OD process. For this purpose the OD process tool 103 is provided. This may be a software module which may be incorporated into the OD server 105 or may stand alone. The raw GPS position data is also supplied to the OD process tool 103. The OD process tool 103 comprises a filter module, generally referred to as an OD filter, configured to filter data in one or more filtering stages to be described further below. Thus the filtering of the raw satellite state data may be performed in parallel to the compiling of the data into a dataset. For this process the OD process tool 103 may maintain a dynamic model of the movement of the satellite. The model may be used to predict the position and/or state of the satellite at any future point in time and is dynamic in the sense that it is updated regularly. In some examples, the model may be updated each time one or more new state vectors are filtered by the filter module of the OD process tool 103. Additionally or alternatively, the model may be updated manually by a user of the system 100.

In an example mode of operation, the OD server 105 at regular intervals copies any measurements from the queue 102 that will have arrived since the previous interval to a working directory. It also maps any required additional meta-data about the satellite to these measurements, which may be in the form of multiple separate ephemeris files. The OD server 105 may then orchestrate running the OD process tool 103 and supply to it these measurements and meta-data in order for the OD process tool 103 to produce the desired filtered and predicted ephemeris measurements.

The metadata mapped to the satellite measurements may include any one or more of satellite mass, satellite centre of gravity, GPS antenna location on the satellite's bus, NORAD (North American Aerospace Defense Command) tracking IDs, ballistic coefficient initial estimation, coefficient of drag and SRP (solar radiation pressure), effective area of drag and SRP, and any other data familiar to those skilled in the art.

In principle the filtering of the satellite data, for example to provide filtered historical and predicted future orbit ephemerides state vectors, may take place before the GPS data is received at the GPS queue 102, or this filtering may take place at the OD server 105, or it may take place elsewhere. As noted elsewhere here, proprietary tools are available for performing this filtering which may be performed in the OD server 105 or performed separately.

In any case it is particularly useful for the filtering to be performed as a separate process from, or in parallel to, the organisation and if necessary the configuration of the GPS data in the OD server 105. In other words, the compiling of the data into a dataset to make it readily accessible via the OD API may be performed on filtered or unfiltered, e.g. raw, data. For example, filtered and unfiltered data may be stored in a database such that both the filtered and unfiltered data are available to the OD API. In some examples the filtered and unfiltered data may be stored in the relational database discussed above—in some cases in separate tables of the relational database. Additionally or alternatively, the filtered data may be inserted into the dataset. One way to implement this would be to replace or overwrite unfiltered data with filtered data in the OD API 105 as it becomes available. Other ways will be familiar to those skilled in the art.

This separation of the filtering from the compilation of the dataset has a number of benefits. For example it may help to avoid delay in the data being accessible that might be caused by the filtering process. The filtering process will typically require a minimum amount of raw data before the filtering can begin or before a required amount of confidence can be attributed to the filtered data. Thus for example on initial launch of a satellite there may be a time delay before the minimum amount of raw data is acquired. The time taken for the acquisition of this minimum amount of data may cause a significant delay in the accessibility of the filtered data via the API and it may be useful for the unfiltered data to be accessible via the API in the meantime. For example, the time delay after the initial launch of the satellite before the minimum amount of raw data is acquired may be six hours or more, twelve hours or more, eighteen hours or more, twenty-four hours or more, thirty-six hours or more, forty-eight hours or more, seventy-two hours or more, or one-hundred-and-twenty hours or more.

The separation of the filtering process from the compilation, and optionally other operations taking place at the OD server, may help to ensure that data is available via the API sooner that might otherwise be possible. The availability of the raw data via the API may facilitate operations to be performed on the satellite, particularly on initial launch. One such operation might be manual calculation of the position and/or state of the satellite on initial launch, which may be desirable for example if any anomaly is noticed. Also it is useful for the unfiltered data to be available early as some determinations about the state of health of the satellite may be made immediately post launch. For example, by ensuring early availability of the unfiltered data it may be possible to check that the GPS data is being safely received at the GPS queue 102 and/or that any related subsystems are receiving the data and any associated measurements. In some examples, this may be done by ensuring that the time gaps between consecutively received state vectors are not so large as to indicate that one or more state vectors have not been successfully and safely received at the GPS queue 102, i.e. that there are no state vectors ‘missing’ from GPS queue 102.

Further, early availability of the unfiltered data may facilitate an early determination of the orbital state of the satellite 100. Access to unfiltered GPS data may enable the OD server to determine the orbital state of the satellite 100, for example by two line element (TLE) generation. TLEs may be used to define the orbital state of the satellite 100 and may be distributed to an external device and/or server, for example a ground station or an internal computer on board the satellite such as an internal pass planner. TLEs may be distributed to such devices and/or servers to that data related to each orbital pass of the satellite may be synchronised between devices and/or servers, and/or so that the satellite may be tracked by one or more antennas of a ground station.

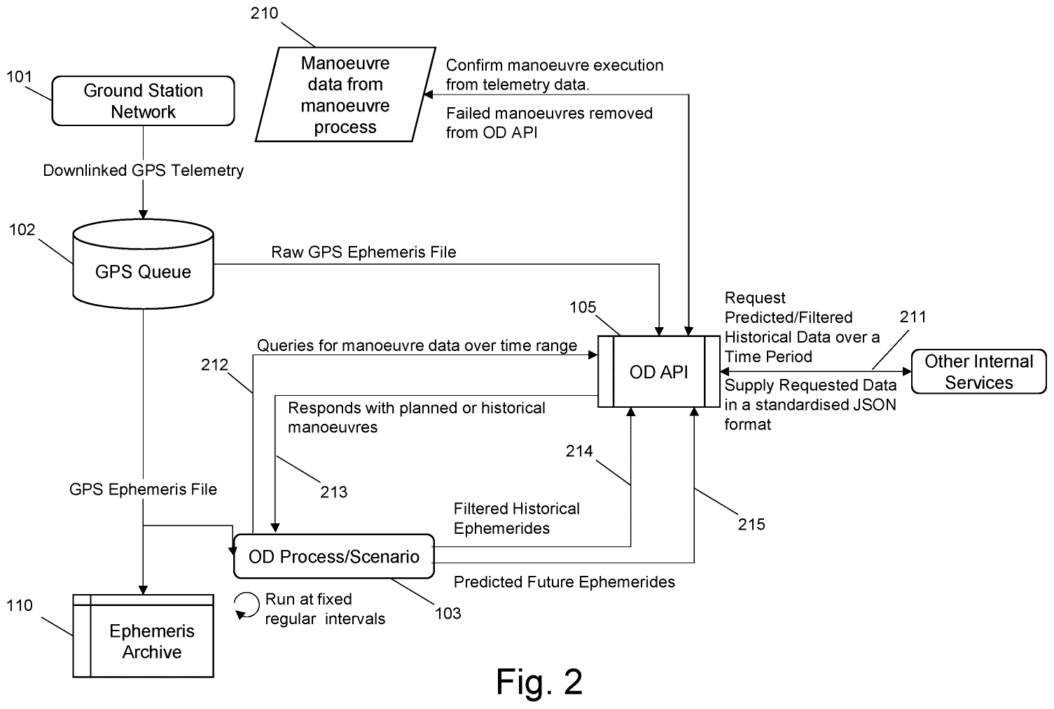

The OD server 105 as illustrated in FIG. 1 provides a source of readily searchable, ideally but not necessarily yet filtered, measurements for actual position, velocity and time (ephemerides' state vectors), and may additionally also provide a source of readily searchable predicted future position, velocity and time, to be described in more detail with reference to FIG. 2.

The OD server 105 and OD process tool 103 may be hosted and run independently from any ground station and communication systems, for example, using a cloud computer provider.

As already noted and as indicated in FIG. 1, the OD process tool 103 is able to output not only filtered ephemerides based on received raw data but also predicted future ephemerides which may be used in other parts of the system, such as for image acquisition planning. The predicted future ephemerides may change if a future manoeuvre is to take place.

The system 10 of FIG. 1 allows for the possibility of supplying to the OD process tool data relating to one or more future scheduled manoeuvres of the satellite for use in the filtering of the received satellite position data. In addition the OD process tool may receive data relating to past scheduled manoeuvres of the satellite for use in the filtering process.

It should be noted here that in general there are two types of manoeuvring, those which change the orbit of the satellite and those which do not. A manoeuvre to change or correct the orbit, for example to maintain a specific orbit or to avoid a collision, is executed with the propulsion system of the satellite, e.g. thrusters of a propulsion unit. In addition, attitude manoeuvres may be commanded and executed from an ADCS unit. Those manoeuvres may not change the orbit. They may be used for downlink/imaging/etc. Attitude manoeuvres may be executed by rotating a component of the satellite. According to the principle of conservation of angular momentum, the satellite may rotate in an opposite sense to the rotation of the rotated component. The rotated component of the satellite may be, for example, an actuator of the ADCS unit. The actuator may comprise one or more of: reaction wheels, torque rods, momentum wheels or other rotational components.

In the system of FIG. 1, the raw GPS data is stored in an ephemeris archive 110.

The filtered and predicted output from the OD server 105 may take the form of a file which may be stored on a computer disk. When this has been produced, the OD server 105 may transfer this file over a computer network using a predefined Application Programming Interface (API) to an archive 112 for cataloguing and storing this produced data. The archive 112 may provide functionality for searching the entire historical record of orbits over a continuous time period and supplying this data in a standard response format—as opposed to supplying individual files as produced from the GPS queue. This archive 112 may be combined with the ephemeris archive 110. In some examples, OD server 105 may be configured to provide the user of system 110 with the functionality to search through the archive 112 and/or ephemeris archive 110. In this sense, OD server 105 may be operable as a database interface to query the archive 112 and/or ephemeris archive 110 which may be operable, separately or together, as databases in which the outputs of GPS queue 102 and/or OD server 105 have been catalogued and/or stored. The data stored in the databases may be searchable and accessible as a continuous stream of data.

As with the OD server 105 and other components of the system 10, the archive may advantageously be hosted separately from other parts of the system and may be duplicated geographically, or across multiple networks for high availability or performance reasons.

As new values for predictions will typically have overlapping time periods the OD server 105 may remove old values from the archive 112 and only serve the latest produced ones. Upon receiving acknowledgement of storage, the archive may permanently remove downlinked files from the GPS queue 102 so that they are not re-processed. If there is an error, they may be left to be re-processed automatically at the next run.

Further business processes may use the OD server 105 to retrieve orbit data for their required time period, as opposed to taking inputs from discrete files. These processes may include the programmatic submission of predicted orbits to a third party service for the purposes of collision avoidance, thus automatically determining whether any planned manoeuvres may be safe to carry out.

In the system of FIG. 1, the filtered ephemeris data is shown to be supplied to orbital simulator 115 and processor 120. The predicted data is shown to be supplied to image scheduler 125.

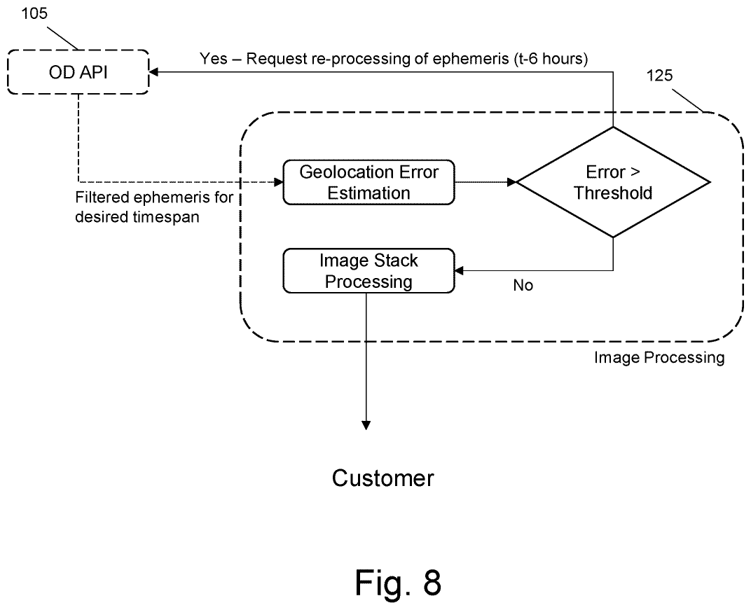

The data may be processed in various ways as is known in the art in the OD server 105. The processing may be performed in any suitable way at any suitable location, including for example using cloud based services. The ability to provide the data via a server is particularly useful for the serving of the data to processing services. Image processing after acquisition depends on the certainty of knowledge of the satellite state vector (position/velocity components) at a given time (e.g. a scheduled imaging time). Filtered ephemeris (after orbit determination) can provide low uncertainty state vectors improving in this way image processing quality, as described further with reference to FIG. 8.

The predicted data may be used for image scheduling in image scheduler 125. Image scheduling relies on accurate predictions of future locations and times of the passing of a satellite to ensure that the best possible image of a specific location is formed, for example using every pass of the satellite over the location. Both image planning (place and time) and radar mode set up depend on the accuracy of predicted ephemeris. In this context, ‘radar mode setup’ may be a computational script (i.e. a computer-readable medium including logic) that when executed sets or determines parameters associated with imaging procedures conducted by the satellite. For example, the radar mode set up may set the time at which imaging procedures begin. Additionally or alternatively, the radar mode set up may set or determine the repetition frequency with which an imaging signal is emitted by the satellite, that is the radar mode set up may set or determine the pulse repetition frequency on a processing board of the satellite. In the system shown in FIG. 1 this is being provided by the designed OD API, and the accuracy will improve after every pass with the downlink of new ephemeris data.

The image scheduler 125 may request data from the OD server 105. The data may be in JSON or any other suitable format compatible with an API. Importantly the predictions are no longer in the form of an ephemeris file. As a result of the configuration of the data in the OD server 105, the image scheduler can ask for data relating to a particular time slot and may obtain only a small amount of data. Operations that may be performed by an image scheduler 125 are described further with reference to FIG. 8.

It is necessary to manoeuvre a satellite from time to time for example to ensure that it is on a repeat track, i.e. its orbit is maintained, for example to be at the same place at the same time every day or to comply with some other requirement, or to change its orbit This may be particularly important in a large constellation of satellites with different satellites monitoring different locations at different times. Therefore, at certain time intervals, e.g. periodically, e.g. weekly, orbit maintenance may be planned.

In the system of FIG. 1, for the purpose of orbit maintenance, satellite position and/or state data, for example obtained via the server 105 API, may be ingested into an orbital simulator 115.

The orbital simulator 115 may simulate the movement of the satellite in order to determine parameters for a manoeuvre to return the satellite to the desired orbit, or to achieve a new orbit, such as time and thrust (propulsive force) duration, discussed further below. After the simulation, the determined parameters for the manoeuvre may be supplied to a collision avoidance service, indicated as collision avoidance API 130.

In the system shown in FIG. 1 the manoeuvre parameters are fed into the orbit determination module indicated at block 127. The orbit determination module 127 may determine the new orbit of the satellite if the manoeuvre takes place, for example using a dynamic model of the satellite's movement which may be the same model used in the OD process tool 103. In other words, as discussed above, the model may be updated each time one or more new state vectors are filtered by the filter module of the OD process tool 103. Additionally or alternatively, the model may be updated manually by a user of the system 100. In this way the determination of the new orbit may be based on the most recent (i.e. up-to-date) measurements/determinations of the satellite state vectors.

Collision avoidance services are known in the art and are provided to avoid collisions between satellites or between satellites and space debris. Details of a planned manoeuvre may be supplied to the collision avoidance API 130 which may be supplied with similar details from other satellite operators as well as the existing orbits of other satellites and other objects in space. The collision avoidance service will in response provide a probability of collision. A decision is made at decision block 135 in FIG. 1 whether the collision probability CP is sufficiently low that a manoeuvre may be carried out. If yes, an instruction to perform the manoeuvre is provided to operation controller 140 to manoeuvre the satellite 100.

Collision services continually monitor the movements of other satellites and objects in space to detect possible collisions. Thus a satellite may subscribe to a collision avoidance service and regularly notify the CA API of its state so as to be warned of collision risks in the absence of any planned manoeuvres. Thus the collision avoidance operations described with reference to FIG. 1 may be in addition to regularly notifying the collision avoidance API of the satellite ephemerides and predictions, not shown in FIG. 1.

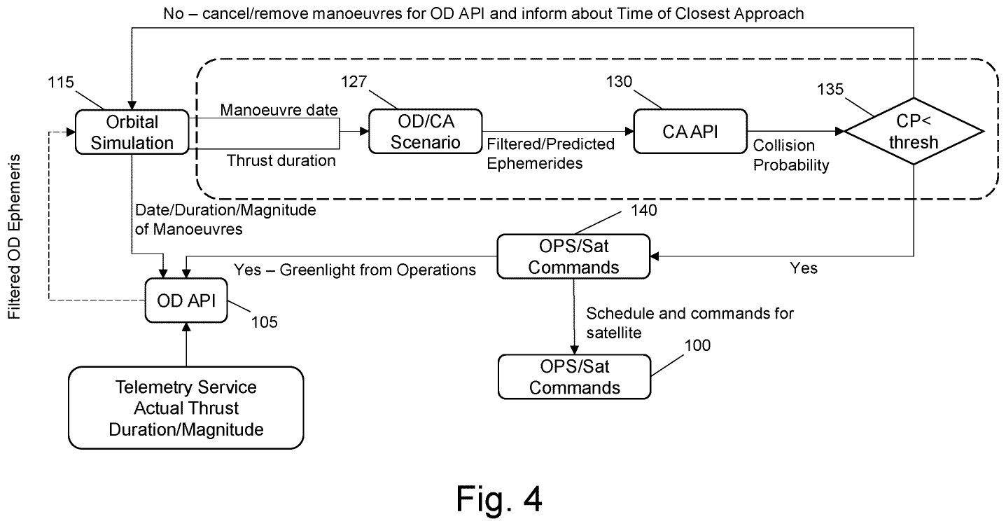

An example collision avoidance process where a manoeuvre is planned is described below in more detail with reference to FIG. 4.

The dotted line at the top of FIG. 1 shows manoeuvre parameters relating to a scheduled manoeuvre being supplied back to the OD server 105.

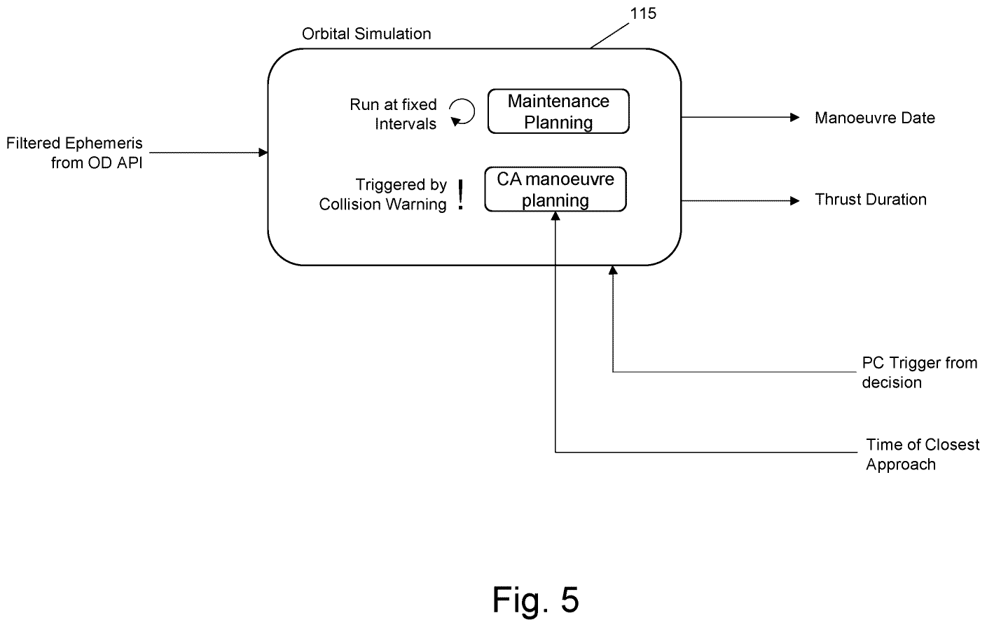

In any of the methods and systems described here the planning of a manoeuvre may be performed automatically, i.e. with no human intervention, in response to receiving the collision probability. In general the system of FIG. 1 is performing a method in which the manoeuvre is scheduled according to the collision probability. For example the manoeuvre may be postponed from a planned time if the collision probability is larger than a threshold value. Rather than simply performing the manoeuvre at a different time from the determined time, it may be necessary to re-run the collision probability determination with different times until a time is found with a collision probability below the threshold. This is described further with reference to FIGS. 4 and 5.

A system as described here may be used to ensure that a satellite is in its correct orbit with minimum collision probability. It may also be configured to perform manoeuvres only after a particular task has been performed.

### Use of Manoeuvre Data in Position Data Filtering

FIG. 2 is a schematic diagram showing in more detail operations that may be performed by the OD server 105 and the OD process tool 103 of the system of FIG. 1. In particular FIG. 2 shows how manoeuvre data may be used in the filtering of raw satellite position data.

FIG. 2 shows that the raw position data, e.g. GPS data supplied by the ground station network 101, is supplied to the ephemeris archive 110, the OD process tool 103 and the OD server 105. In addition the OD server 105 is supplied with manoeuvre data from manoeuvre processes, as indicated by block 210, for example including manoeuvre parameters. This data may relate to scheduled future manoeuvres and/or manoeuvres that have taken place. For example received data relating to a past manoeuvre may confirm that a scheduled manoeuvre did take place or that the satellite was instructed to perform a scheduled manoeuvre. Additionally or alternatively, received data relating to a past manoeuvre may include information related to the direction, magnitude and/or direction of any forces applied to execute the past manoeuvre. Thus, the system may be configured such that data relating to scheduled manoeuvres, e.g. one or both of historic and future manoeuvres, is used as an input to the OD filter in the OD process tool 103, for use in filtering the raw ephemerides, in addition to the raw GPS data. This additional input data to the filter may help to reduce the margin of error in the filtered data.

The OD API at the OD server 105 may be used to request and obtain data for use by other services, including services internal to the operation of the satellite. Such services may include so-called pass-scheduling, that is a determination of when a given satellite will be within an operating communication range with a particular ground station, including both at what time the given satellite will enter the operating communication range and how long the satellite will remain within range. This may be useful for determining time windows during which software updates can be delivered to the given satellite from the ground station. An example message flow is indicated in FIG. 2.

The OD API may receive a request 211 for data, for example position and/or state data, over a particular time period. The time period may be in the past or the future or may span the past and the future. In some examples, the time period may extend 12 hours or more into the past, 24 hours or more into the past, 48 hours or more into the past, 72 hours or more into the past, or as far back into the past as possible based on historic data. In some examples, the time period may extend 6 hours or more into the future, 12 hours or more into the future, 18 hours or more into the future, 24 hours or more into the future, 36 hours or more into the future, 48 hours or more into the future, 72 hours or more into the future, or 120 hours or more into the future. The OD process tool 103, for example under the control of the OD server 105, may send request 212 to the OD server via the OD API to provide manoeuvre data over a particular time range. The sending of request 212 may be in response to the receiving of request 211 and may relate to the particular time range specified in request 211. Additionally or alternatively, the system of FIG. 2 may operate such that a query 212 is transmitted periodically to the OD process tool 103 to obtain data so that it is already available via the API to be served in response to the request 211. A periodical request may relate to the same period of time relative to the moment when it is transmitted, e.g. the previous and future 24 hours, or the previous and future 48 hours. In other words, the OD server 105 or the OD process tool 103 may receive the manoeuvre data at regular intervals or periodically for consecutive periods of time so that the received manoeuvre data relates to contiguous time periods. Then the OD process has a readily accessible supply of manoeuvre data for use in the filtering process.

The OD API transmits a response 213 to the OD process tool 103 with details of planned and/or historical manoeuvres during the particular period specified in the request 212. Details of a historical manoeuvre may include the duration of the manoeuvre, the start time of the manoeuvre, the stop time of the manoeuvre, the magnitude of the thrust/burns associated with the manoeuvre, and/or the attitude of the thrust/burns associated with the manoeuvre. Details of a planned manoeuvre may include the duration of the manoeuvre, the magnitude of the thrust/burns associated with the manoeuvre, and/or the attitude of the thrust/burns associated with the manoeuvre. Details of a planned manoeuvre may further include projected/planned start and/or stop times of the manoeuvre. If some or all of the time period is in the past, the OD process tool 103 uses the historical manoeuvre data in the filtering of the raw GPS data to output filtered ephemerides 214. For example, the OD process tool 103 could form a more accurate historical force model using historical manoeuvre data as an input to update the statistical model (produced by, for example, an Extended Kalman Filter) of the satellite's orbit. Anomalous data points, caused by the non-expected manoeuvre, in the raw GPS data could now be identified—as a manoeuvre—and smoothed out to provide the filtered ephemerides 214. Additionally or alternatively, if some or all of the time period in the query 212 or the request 211 is in the future, the OD process tool uses this to produce predicted future ephemerides 215 which are transmitted from the OD process tool 213 to the OD server 105. The ephemerides output from the OD process tool 103 to the OD server 105 may then be supplied by the OD server 105 to the requesting service. This requesting service may be serving a process internal or external to the satellite.

In a specific example of operation of the OD filtering process, the OD filter in the OD process tool 103 is supplied with manoeuvre data which may include duration and time of each manoeuvre, each manoeuvre being either a historic or future, planned, manoeuvre. Commands transmitted in order to effect a manoeuvre may also be notified to the OD filter by way of confirmation that a planned manoeuvre was commanded to take place. If the confirmation fails, i.e. it is determined that the manoeuvre was not commanded to take place, or that the manoeuvre was not executed then the data associated with the manoeuvre may be deleted. In some examples, there may be a separate process, for example a tasking service, that logs whether a command to execute a given manoeuvre was successfully transmitted to the satellite and, latterly, whether the manoeuvre was successfully executed. The OD filter may (re) create the manoeuvre, e.g. model the manoeuvre by importing the received manoeuvre data, and use this in the determination of the position and/or state of the satellite at any past or future time. As noted elsewhere, the OD filter may use a dynamic model of the movement of the satellite in the filtering process as is known in OD determination. Manoeuvres, once imported into the OD process, may be used to redefine the dynamic model for the satellite for the specific period of time of a particular manoeuvre. So they are only used to produce the desired OD solution (filtered data) or prediction (ephemeris created based on theoretical dynamics models and not actual measurements).

The desired/predicted attitude of the spacecraft is also described in the OD process in order to fit the satellite's dynamic model. This attitude data may be gathered on every pass of the satellite. The attitude data may be stored, for example, in an attitude file that is appended to on every pass of the satellite. By including attitude data with the state vector data the precise movements of the satellite can be modelled. This precise position model can be combined with state vector measurements (for example GPS measurements), and/or the dimensions of the satellite to improve the reliability and precision of the dynamic model, thereby resulting in a more accurate filtering of data by the OD filter. This consequently improves the accuracy of any predictions made based on the dynamic model and therefore improves the planning of orbital manoeuvres and improves the accuracy of any post-processing of orbital information.

More specifically, the OD filter may output filtered position data based on different estimates of position, wherein the different estimates include the raw position data and an estimate of position based on a scheduled manoeuvre. Additionally or alternatively, the OD filter may output state vectors (i.e. datasets comprising both position and velocity data). These state vectors may be predicted state vectors for a future state of the satellite and may be derived from a propagation forward in time of the orbital data, taking into account the dynamic force model that has been created. This may also take into account any scheduled manoeuvres of the satellite. When predicting the ephemerides state vectors, raw state vector data—for example, raw position data in the form of raw GPS data—may simply be an initial starting point for the processing from which the future orbital direction of the satellite may be determined. In examples where the initial state vector of the satellite is well-defined and accurate, the reliability (i.e. trustworthiness) of the predicted trajectory/orbit may be improved.

In one example of operating the OD process, in the OD filter two types of filters (statistical processes) are applied in a process including the following steps:
1) BWLS (Bayesian weighted least-squares)—this is basically a curve fitting process. It does not use any dynamic model and is used to give a better initial guess in order to move to a next filtering step. Here all the data is processed at once.
2) The next step is OSF (ordered statistics filtering)—this is a Kalman filter-here the data is processed sequentially. A dynamic model is used here in order to make the most accurate update. Best state minimizes the state estimate uncertainty. Uncertainty of the model is determined from the size and variability of this uncertainty (Process Noise). Here we are moving from old data to the newer data.
3) Second OSF—also called a smoother. Same as (2) but inverted in time. The Kalman filter is trying, in general to minimize state uncertainty having the knowledge of the previous state's convergence (uncertainty level) and is using the dynamic model in order to create the best guess.

In both of stages 2 and 3 the dynamic model may be based on a future scheduled manoeuvre of the satellite. The dynamic model may be further based on data associated with historic manoeuvres of the satellite. Using data associated with historic manoeuvres of the satellite may improve the accuracy of the dynamic model, that is it may lower any uncertainty values associated with the dynamic model.

It should be noted that the OD process may be ignorant of the passes of the satellite over the earth or other manoeuvres. Systems querying the API for orbit data are unaware of any manoeuvres either in the future or the past and do not need to take them into consideration to perform tasks-manoeuvres having been represented sufficiently in both predicted and filtered orbit data supplied by the API. The OD process may be configured to request new data from the OD server 105 automatically, for example at regular intervals or in response to receiving new raw data. The OD process may be configured to continuously provide predicted ephemerides or position data in another form for a predetermined time period in the future so that the process is, for example, always “thinking” 24 hours ahead. The process may run anywhere on any suitable computing device such as a laptop device, and may in theory run in a computing system onboard the satellite.

The OD process tool 103 may provide an automated way of confirming that a planned manoeuvre did take place. In one example, propulsion telemetry from the satellite may be monitored, for example programmatically. When a manoeuvre is to take place, a specific magnitude of thrust from specific thrust modules is expected. If this expected magnitude is not detected, it may be assumed that the manoeuvre has failed, i.e. was not executed, and data relating to that manoeuvre may be removed automatically from the OD process, e.g. data relating to the planned manoeuvre that was previously supplied to the OD process tool 103 may be removed or discarded. The data associated with the magnitude of thrust that is detected may be measured directly from the thruster and/or inferred from position data of the satellite after the thrust has been applied. In other words, in some examples, the magnitude of the thrust may be determined based on telemetry data indicative of the position and/or velocity of the satellite after the thrust has been applied. In some examples, there may be a difference between the theoretical orbit behaviour of the satellite (based on the predicted magnitude of thrust from the thrust modules). The OD process tool 103 may determine a thrust correction that adjusts the magnitude and/or direction of the thrust applied by the thrust modules based on the difference between the past actual and theoretical orbital behaviours to minimise the difference between future actual and theoretical orbital behaviours. Further, re-initialization of a scenario, for example resulting from that thrust correction may be commanded for a particular period of time (e.g. T−6 Hrs). Re-initializing the scenario may involve resetting the dynamic model of the satellite so that the model only accounts for a short period of recent measurements (e.g. measurements from the preceding six hours) instead of being built up from all previously made measurements. In this way, the memory requirements of the OD process tool 103 can be reduced. In the context of image acquisition from a satellite, this procedure may run for every pass for images scheduled in T+24 hrs. This enables the avoidance of processing and tasking errors due to failed manoeuvres. The orbital simulator 115 should also be alerted to the failed manoeuvre for example via an output from the OD server 105 since the failed manoeuvre, for orbit maintenance or collision avoidance or other purpose, still needs to be performed. A maintenance process will run again, for example command the propulsion system to generate additional burn (in other words, thrust), usually after prior checking for collision probability via the collision avoidance API 130. In case of a collision avoidance manoeuvre, similarly the propulsion system may be commanded to generate additional or correction burn or thrust.

In the system described with reference to FIGS. 1 and 2, the OD server 105 is responsible for the cataloguing of data it receives including but not limited to any of raw GPS ephemerides, filtered historical ephemerides, predicted future ephemerides, and manoeuvre data. Any of this data may be supplied to the server 105 as discrete items, e.g. individual files. For example ephemerides are typically supplied in a file per pass of the satellite and manoeuvre data may be supplied as a discrete item per manoeuvre. The cataloguing of this data by the server or by any other suitable computing system enables the data to be searched in various ways, for example per time period, or in a specific coordinate system. Further, this cataloguing can be performed for multiple satellites in the same constellation by the same server or computing system. Then, for example, it is possible to obtain satellite position over a period of time, satellite manoeuvres over a period of time, and other information as will be familiar to those skilled in the art, for one or for a group of satellites.

### Quality Control of OD Process

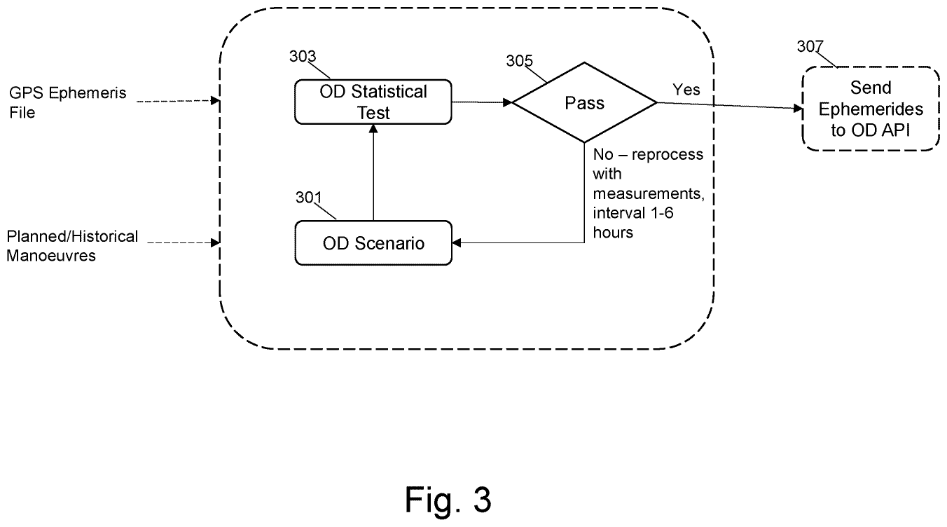

FIG. 3 is a block diagram showing a quality control “QC” system that may be used to ensure that accurate predictions are submitted to the API of the OD server 105. The QC here may consist of using proprietary tools to create statistics along with its own decision and retry logic implemented in the OD server 105.

The QC process of FIG. 3 may be incorporated into the system of FIG. 1 to ensure that only data of a particular quality is supplied to the OD server 105. The process may be implemented as part of the OD process tool 103 or in a separate quality control module between the output of the OD process tool 103 and the input to the OD server 105. Either way, the operation of the process shown in FIG. 3 may be controlled from the OD server 105 to operate automatically, not requiring manual intervention.

In FIG. 3 the quality control process is assumed to take place in the OD process tool 103 and receives as input data raw GPS data. In addition, the details of planned and historical manoeuvres may be used in the process. An OD scenario is then created as indicated at 301, the results of which, in the form of filtered ephemerides, are subject to a statistical test 303. The statistical test may test the reliability of the scenario data in any suitable manner, for example a confidence value above a predetermined threshold. A proprietary third party statistical software tool may be used to perform the statistical test. If the filtered ephemerides meet the confidence threshold at decision 305, the filtered ephemerides are transmitted to the OD server 105 at 307 in a flow similar to 214 in FIG. 2. Otherwise the flow returns to 301, this time with additional input data, for example spanning an earlier or longer period in time. Then, additional information from the GPS queue 102 may be requested in order to re-run operations 301, 303, 305. In the example of FIG. 3, additional measurements from the previous 6 hours are requested, whereas in the first iteration only data from the previous hour might have been used.

### Collision Avoidance

FIG. 4 is a block diagram showing in more detail a collision avoidance process which may be implemented in the system of FIG. 1. The orbital simulator 115, orbit determination module 127, collision avoidance API 130, and decision block 135 may operate in the same manner as described already with reference to FIG. 1.

In general, manoeuvre data such as that output from the orbital simulator 115 to the orbit determination module 127, may comprise date or more precise time for the manoeuvre, thrust duration, magnitude and pointing direction of the thrust, the specific impulse of the thrust, and the attitude of the satellite. Only date and thrust duration are shown in FIG. 4 for simplicity.

If the collision probability is determined to be low at decision block 135, for example below a predetermined threshold, a command is sent to the operation controller 140 to manoeuvre the satellite 100 from the operation controller 140. Further, the details of the planned manoeuvre, for example including date and duration, are transmitted to the OD server 105. This may be all or part of the manoeuvre data passed to the OD server 105 in block 210 in FIG. 2, and may then be used by the OD server controlling the operation of the OD process tool 105 to produce filtered OD ephemeris data which is fed back to the orbital simulator 115.

If the collision probability is determined not to be low at decision block 135, the orbital simulator is informed of the time of closest approach of a possible collision, which is fed back to the orbital simulator in order for new manoeuvre parameters to be determined.

FIG. 5 is a block diagram showing operations that may be performed by the orbital simulator 115.

As noted in FIG. 4, the orbital simulator 115 receives filtered ephemerides via the API of the OD server 105. In FIG. 5 two processes of determining manoeuvre data are shown to take place in parallel. One, for maintenance of the satellite in a particular orbit, takes place at regular intervals, for example every two weeks. The other, for collision avoidance, is triggered by a collision warning, for example a notification that the collision probability is above a predetermined threshold, either due to the satellite continuing in its current orbit or due to a planned manoeuvre. Collision avoidance manoeuvre planning may be based on one or both of the collision probability and time of closest approach, to ensure that the new manoeuvre data defines a manoeuvre that is less likely to result in a collision. This new manoeuvre data is then supplied to the collision avoidance API 130 for the determination of collision probability to be determined again. The steps of determining manoeuvre parameters, receiving a collision warning and determining new collision parameters may be repeated until the new collision parameters do not result in a collision warning.

### Manoeuvre Planning for Satellite Capability

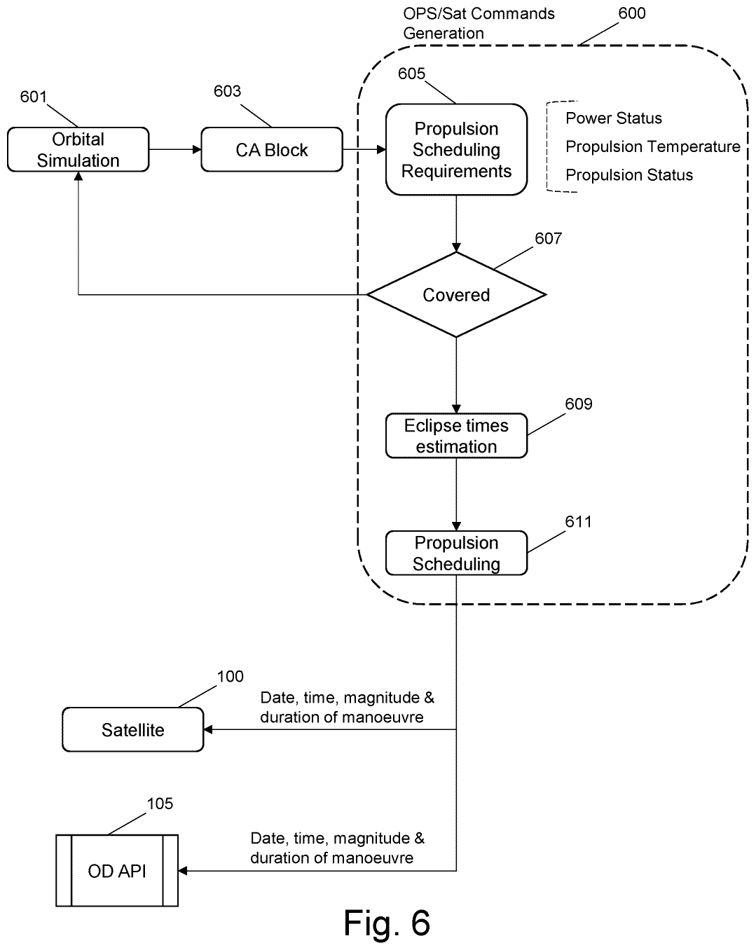

In addition to manoeuvres being planned for orbit maintenance and collision avoidance, the planning of a manoeuvre may also take into account the current conditions of the satellite, for example its propulsion system. Additionally or alternatively, the position of the satellite in relation to the sun may be taken into account, for example to avoid the propulsion system operating when the satellite is fully exposed to the sun and is in danger of overheating. A possible process of manoeuvre planning is shown schematically in FIG. 6, which may be implemented in the system of FIG. 1.

In the process shown in FIG. 6, first at operation 601 orbital simulation takes place to determine manoeuvre parameters, for example time, duration, magnitude and pointing direction. The parameters are then subject to a collision avoidance process as described above and represented by CA block 603. It may then be assumed that manoeuvre parameters resulting from the CA process satisfy a requirement for a low collision probability. Thus the flow in block 600 begins with receiving parameters for a planned manoeuvre to move the satellite from a current orbit to a new orbit, wherein the parameters include time and duration of the manoeuvre. The parameters may specify a time window for the performance of the manoeuvre within which the manoeuvre may be scheduled to take place according to one or more other restrictions on when the manoeuvre may take place, including one or both of exposure to the sun and current capability of the satellite propulsion system.

Next, at operation 605, the propulsion scheduling requirements to effect the manoeuvre are determined and at operation 607 it is decided whether the requirements can be met. Factors that may be taken into account when determining the propulsion scheduling requirements may include any one or more of power status, e.g. available battery, propulsion temperature and propulsion status. For example, in some cases, the thrusters may need to be heated to a specific temperature in order to fire. This temperature may be referred to as the propulsion temperature. The propulsion temperature may be 125 degrees centigrade or more, 150 degrees centigrade or more, 175 degrees centigrade or more, or 200 degrees centigrade or more. In a particular example, the propulsion temperature may be 173 degrees centigrade. The propulsion status may comprise data indicative of the status or performance of various components of the satellite. For example, the propulsion status may be indicative of which, if any, of the modules of the satellite are damaged or suffering from failure (for example fault detection, isolation, and recovery (FDIR) resets, etc.).

If the propulsion scheduling requirements cannot be met within the time window, iterations of the orbital simulation 601 and CA process 603 are performed until manoeuvre parameters are determined that the satellite can perform.

Then in operation 609 estimates of eclipse times are obtained. These indicate when sun is eclipsed by the earth so that the satellite is in the shadow of the earth. It is preferable to perform manoeuvres when the sun is eclipsed by the earth, in order to ensure that the satellite does not overheat when performing a manoeuvre. The combined effects of heat from the sun and heat generated by the satellite propulsion system may cause the satellite to overheat and be damaged. In practice it has been found to be sufficient to avoid operating the propulsion units while they are facing the sun, and this can be achieved by scheduling the time of the manoeuvre to avoid a proportion of the orbit during which the exposure of the satellite to the sun is maximum, for example the quarter of the orbit during which exposure is maximum. Then operation of the thrusters occurs for no more than three quarters of each complete orbit around the earth, or pass, avoiding the quarter-orbit of maximum exposure to the sun.

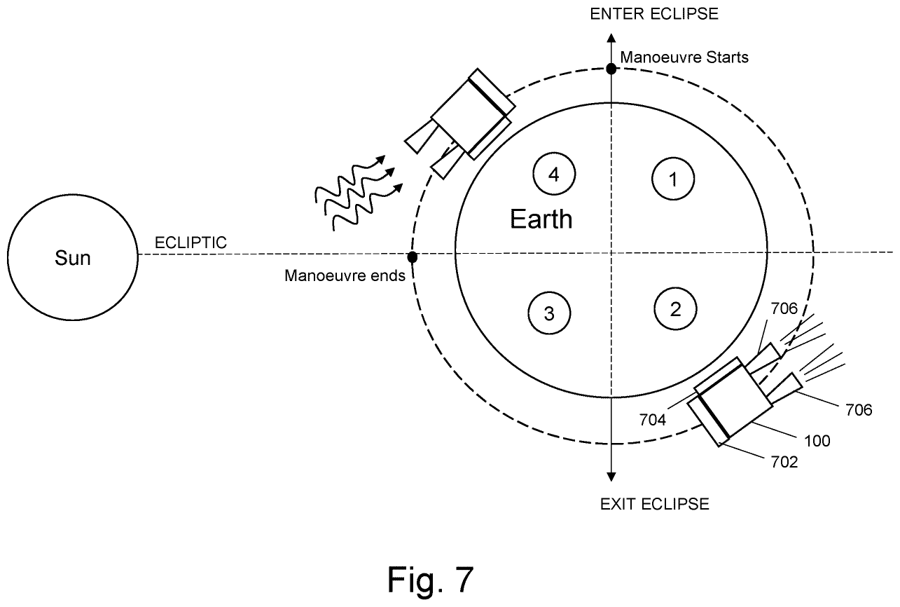

FIG. 7 shows an example satellite 100 which may be operated using the systems and processes described here. The satellite comprises a generally cuboidal body, referred to in the art as a “bus”. A solar panel 702 is mounted on a rectangular surface of the body and additional solar panels are attached to this via struts. The satellite comprises a generally planar structure extending from the body in two opposing directions to provide two “wings” which can support an antenna array 704 and other components. When the satellite is in orbit the surface of the “wings” opposite to the body generally face the surface of the earth. The satellite is provided with a propulsion system 706 for manoeuvring the satellite with a generated thrust. The propulsion system is mounted on the body on the surface opposite to the solar panels. The propulsion system comprises a plurality of thrusters 706 that produce thrust for manoeuvring the satellite when required. The thrusters of the FIG. 7 satellite are positioned at the corners of one side of the body and may be equally spaced apart.

The propulsion system is used to manoeuvre the satellite 100 to change the satellite orbit, or altitude. As noted elsewhere here this might be for example to maintain the satellite in a particular orbit if its altitude has changed slightly or to avoid a collision with another object in space. Additional manoeuvres of the satellite are possible, for example to change the attitude of the satellite, for example for a particular imaging mode. Thus, whereas with a large satellite imaging equipment might be manoeuvred with respect to the satellite for particular image acquisition procedures, a satellite 100 such as that shown in FIG. 7 may be a micro satellite, whose smaller size and greater agility may allow it to be manoeuvred in its entirety to change its attitude. This kind of manoeuvre may be performed using the satellite ADCS unit.

Satellites may be categorised according to their mass. For example, a satellite having a mass between approximately 1 kg and approximately 10 kg may be categorised as a cube satellite; a satellite having a mass between approximately 50 kg and approximately 250 kg may be categorised as a micro satellite; a satellite having a mass of approximately 500 kg may be categorised as a small satellite; and a satellite having a mass between approximately 800 kg and approximately 1200 kg may be categorised as a regular satellite.

In an example, satellite 100 may a Micro satellite with a mass of 100 kg. Regular satellites having a mass of approximately 1000 kg are generally more expensive and less agile than Micro satellites. Embodiments of the manoeuvre planning, collision avoidance, orbit changes, and other methods described herein can be applied to one or more Micro satellites each with a mass of between 50 kg and 250 kg.

It will be apparent from the foregoing that for the majority of the travel of the satellite 100 the propulsion system 706 is shielded from the sun by the satellite body but during the orbital quarter indicated as quarter 4 in FIG. 7 the propulsion system 706 is exposed to the sun and therefore it is desirable to avoid operating the propulsion system 706 during this time. Therefore the information relating to eclipse times may be used to plan manoeuvres to avoid this part of the satellite orbit.

For example, at the beginning of the orbit quarter indicated as quarter 1 in FIG. 7, the satellite 100 may enter an eclipse of the sun by the earth. Therefore, the manoeuvre (using the propulsion system 706) is started in quarter 1 of the orbit. The satellite 100 may exit the eclipse at the end of quarter 2, as indicated in FIG. 7. However, during quarter 3 of the orbit, the body of the satellite 100 shields the propulsion system 706 from exposure to radiation from the sun. It is not until the satellite has crossed the ecliptic line, marking the start of quarter 4 of the orbit, that the propulsion system 706 is exposed to solar radiation. Therefore, the manoeuvre (using the propulsion system 706 is ended in, or at the end of, quarter 3 of the orbit.

For a satellite in low earth orbit an eclipse typically lasts for 34.5 minutes and an orbit lasts for 95.6 minutes.

In operation 611 the manoeuvre is scheduled to take place during a time or times when the satellite is in the shadow of the earth, or at least its propulsion system is not fully exposed to the sun, as explained further above.

The result of operation 611 is that manoeuvre parameters are output to the satellite 100, or operation controller 140 as shown in FIG. 1. These are also output to the OD server 105 as indicated by block 210 in FIG. 2.

It should be noted that in the process of FIG. 6, collision avoidance takes precedence over satellite capability and sun exposure avoidance. In general the process of determining manoeuvre parameters to satisfy the criteria of collision avoidance, satellite capability and sun exposure avoidance, and other criteria which may apply to the determination of manoeuvre parameters, may take place in any order and may vary according to the current conditions.

It will be appreciated from the foregoing that the manoeuvre parameters resulting from the CA process, or whichever process takes precedence, may specify a time window for the performance of the manoeuvre within which the manoeuvre may be more precisely timed to satisfy one or more other criteria.

In order to satisfy various criteria for the timing of a manoeuver, one manoeuvre as defined by parameters output from a first process, such as the CA process, may be scheduled to take place as a series of sub-manoeuvres. For example the time period or window output from the CA process may include at least two orbits of the satellite around the earth. Then the total duration of a manoeuver may be split into shorter periods occurring in different passes of the satellite. Thus the output parameters resulting from operation 611 may comprise date/time for (sub) manoeuvre and duration in addition to magnitude, e.g. the magnitude of the thrust (or burn) force.

### Image Scheduling

FIG. 8 illustrates operations that may be performed by the image scheduler 125 of FIG. 1. The image scheduler operates to compile image data obtained by image acquisition apparatus onboard the satellite to produce composite images in a manner well known in the field of SAR imaging. This process is sometimes referred to as image stack processing, as indicated in FIG. 8. Newly acquired data is continuously added to the image stack. It is important in the compilation of the data that the position of the satellite at the time of data acquisition is accurately known. In the process illustrated in FIG. 8, image data is only added to the stack if the position estimation is sufficiently accurate.

The flow of FIG. 8 assumes that SAR image data has been received that has been acquired during a particular timespan.

As shown in FIG. 8, the image scheduler 125 may request filtered ephemerides from the OD server 105 for the particular timespan. The filtered ephemerides are to be used to estimate or to determine the geolocation error associated with particular image data. The request may be transmitted in response to receiving new image data. Alternatively the request may be transmitted per batch of image data. Alternatively this information may be supplied to the image scheduler from the OD server at regular intervals and not necessarily in response to a request.

As shown in FIG. 8, the filtered ephemerides may be used to estimate a geolocation error for the satellite at a particular point in time. The geolocation error may be determined at the end of each iteration of an OD process. Then it is determined whether the error is high, for example above a predetermined threshold, in which case it is preferred not to import the image data for that time into the image processing stack. Instead, a new request for filtered ephemerides is transmitted to the OD server 105 from the image scheduler 125, following which the geolocation error is estimated again. By virtue of the fact that the estimation is based on a larger data set the resulting error should be lower. Repeat iterations of error estimation and requesting additional filtered ephemerides may be carried out until the error is sufficiently low for the associated image data to be added to the image stack processing.

It is important to note that as the image scheduling is constantly being run it need not be aware of any manoeuvres, orbit changes or collision avoidance being performed by the satellite as these will always be represented in the latest Orbit Determination supplied from the OD API.

### Calibration of Propulsion System

Some of the methods and systems described here may offer opportunities to more accurately control the operation of the propulsion system of a satellite. For example, they may be used in the calibration of the propulsion system. This is particularly useful for a propulsion system that cannot easily be tested on the ground. For example, on ground testing is not recommended for some ion low thrust engines. In such cases the performance of the propulsion system may be estimated, for example in order to estimate position based on commands given to the propulsion system. Such calibration is useful not only on initial operation when on ground testing is not used, but also during operation as the performance of the propulsion system changes with use.

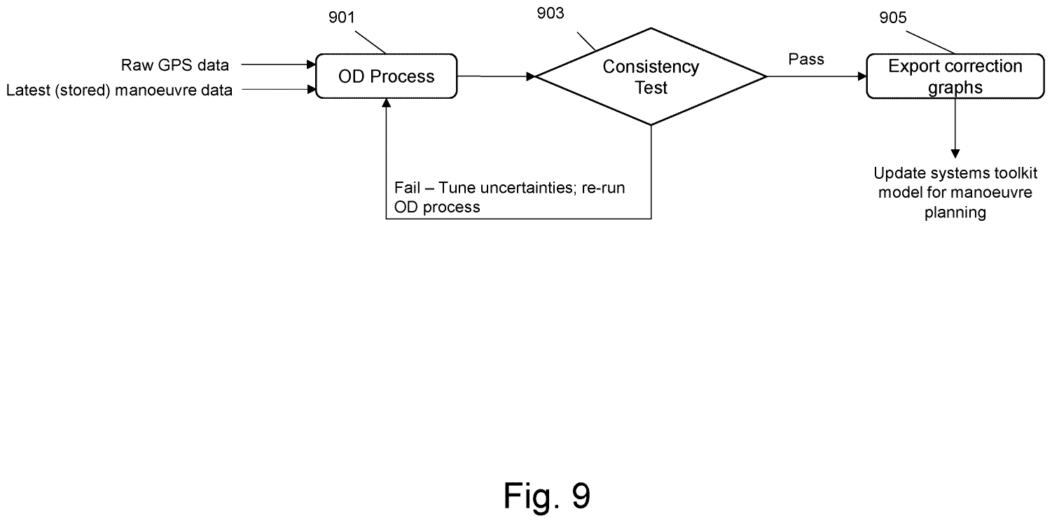

FIG. 9 is a block diagram showing operations that may be performed by a propulsion system calibrator in the system of FIG. 1.

During an OD process 901, the certainty of position obtained from manoeuvre data can be highlighted on one or more parameters, for example one or both of magnitude and pointing. In this way, information can be gained from the OD results about the performance of the propulsion system, e.g. engines or thrusters on a given manoeuvre. Correction estimation reports and graphs can be generated and stored, and then a system engineering team can draw conclusions about performance and move on calibration actions that will result in more accurate manoeuvres/predictions and filtered solutions. Within the OD process 901, there may be an uncertainty model for the manoeuvre input that takes into account uncertainty of thrust magnitude and pointing, amongst other parameters.

In an example calibration process, a manoeuvre is commanded from the operation controller 140. The command comprises thrust magnitude, duration and direction and will be based on an assumed relationship between these parameters and expected change in orbit, or state vector, of the satellite. The command will be intended to change the orbit of the satellite by a predetermined amount. The command is implemented and the satellite orbit changes. The amount of change of the orbit can be determined from the resulting filtered ephemerides. This can be used to confirm or update the assumed relationship. The filtering process to determine the filtered ephemerides will take into account the expected change in orbit of the satellite.

The OD process 901 may receive raw GPS data and the latest (stored) manoeuvre data) based on the latest commanded manoeuvre. From this input, OD process 901 produces an updated orbit model. This updated orbit model includes an uncertainty model that captures the uncertainty in the thrust magnitude and pointing of the satellite manoeuvres, and is subjected to a statistical consistency test 903. If the updated orbit model fails the statistical consistency test 903, OD process 901 refines the orbit model and tunes the uncertainties until the orbit model and associated uncertainty model pass the consistency test 903. Once the orbit model passes the consistency test 903, the finally updated orbit model is passed to a further module to produce a correction model. This correction model may be in the form of correction graphs that are exported 905. The exported correction graphs 905 may then be used to compensate for uncertainty in manoeuvre parameters such as thrust magnitude and pointing in future manoeuvre planning simulations.

Any of the components of any of the systems described here may comprise or be incorporated into a computing system.

Any of the computing systems described herein may be combined in a single computing system with multiple functions. Similarly the functions of any of the computing systems described herein may be distributed across multiple computing systems.

Some operations of the methods described herein may be performed by software in machine readable form e.g. in the form of a computer program comprising computer program code. Thus some aspects of the invention provide a computer readable medium which when implemented in a computing system cause the system to perform some or all of the operations of any of the methods described herein. The computer readable medium may be in transitory or tangible (or non-transitory) form such as storage media include disks, thumb drives, memory cards etc. The software can be suitable for execution on a parallel processor or a serial processor such that the method steps may be carried out in any suitable order, or simultaneously.

In the described embodiments of the invention the system may be implemented as any form of a computing and/or electronic system as noted elsewhere herein. Such a device may comprise one or more processors which may be microprocessors, controllers or any other suitable type of processors for processing computer executable instructions to control the operation of the device in order to gather and record routing information. In some examples, for example where a system on a chip architecture is used, the processors may include one or more fixed function blocks (also referred to as accelerators) which implement a part of the method in hardware (rather than software or firmware). Platform software comprising an operating system or any other suitable platform software may be provided at the computing-based device to enable application software to be executed on the device.

The term “computing system” is used herein to refer to any device with processing capability such that it can execute instructions. Those skilled in the art will realise that such processing capabilities may be incorporated into many different devices and therefore the term “computing system” includes PCs, servers, smart mobile telephones, personal digital assistants and many other devices.

It will be understood that the benefits and advantages described above may relate to one embodiment or may relate to several embodiments. The embodiments are not limited to those that solve any or all of the stated problems or those that have any or all of the stated benefits and advantages.

Any reference to “an” item or “piece” refers to one or more of those items unless otherwise stated. The term “comprising” is used herein to mean including the method steps or elements identified, but that such steps or elements do not comprise an exclusive list and a method or apparatus may contain additional steps or elements.

The figures illustrate exemplary methods. While the methods are shown and described as being a series of acts that are performed in a particular sequence, it is to be understood and appreciated that the methods are not limited by the order of the sequence. For example, some acts can occur in a different order than what is described herein. In addition, an act can occur concurrently with another act. Further, in some instances, not all acts may be required to implement a method described herein.

The order of the steps of the methods described herein is exemplary, but the steps may be carried out in any suitable order, or simultaneously where appropriate. Additionally, steps may be added or substituted in, or individual steps may be deleted from any of the methods without departing from the scope of the subject matter described herein. Aspects of any of the examples described above may be combined with aspects of any of the other examples described to form further examples.

It will be understood that the above description of a preferred embodiment is given by way of example only and that various modifications may be made by those skilled in the art. What has been described above includes examples of one or more embodiments. It is, of course, not possible to describe every conceivable modification and alteration of the above devices or methods for purposes of describing the aforementioned aspects, but one of ordinary skill in the art can recognize that many further modifications and permutations of various aspects are possible. Accordingly, the described aspects are intended to embrace all such alterations, modifications, and variations that fall within the scope of the appended claims.

Examples and embodiments of the present disclosure may be understood with reference to the clauses below.
1. A method of processing satellite state data, the method comprising:
   receiving satellite state data in the form of multiple separate files via one or more ground stations; and
   compiling the received satellite state data into a single dataset accessible via an application programming interface and searchable by time range.
2. The method according to clause 1, wherein the satellite state data comprises raw data.
3. The method according to clause 2, the method further comprising:
   filtering the raw satellite state data in an orbit determination process to provide filtered satellite state data,
   wherein the filtering is performed in parallel with the compiling of the received satellite state data, and
   wherein each item of filtered satellite state data corresponds to an item of raw satellite state data.
4. The method according to any preceding clause, the method further comprising: receiving manoeuvre data relating to one or more scheduled manoeuvres of the satellite and compiling the received manoeuvre data into a dataset accessible via an application programming interface and searchable by time range.
5. The method according to clause 4, as dependent on clause 3, wherein the manoeuvre data is used in the filtering of the received raw satellite state data.
6. A method of processing satellite state data, the method comprising:
   receiving raw satellite state data;
   receiving manoeuvre data relating to one or more scheduled manoeuvres of the satellite; and
   filtering the received raw satellite state data in an orbit determination process to provide filtered satellite state data,
   wherein the manoeuvre data is used in the filtering of the received raw satellite state data.
7. The method according to clause 6, wherein receiving the raw satellite state data comprises:
   receiving the raw satellite state data in the form of multiple separate files via one or more ground stations; and
wherein the method further comprises:
   compiling the received raw satellite state data into a single dataset accessible via an application programming interface and searchable by time range.
8. The method according to clause 7, the method further comprising: compiling the received manoeuvre data into a dataset accessible via an application programming interface and searchable by time range.
9 The method according to any preceding clause, the method further comprising: scheduling a satellite manoeuvre, wherein scheduling the satellite manoeuvre comprises:
   receiving parameters for one or more planned manoeuvres to move the satellite from a current orbit to a new orbit, wherein the parameters include a time and duration of each of the one or more planned manoeuvres;
   receiving times of eclipses of the Sun by the Earth during future orbits of the satellite; and
   scheduling the manoeuvre to take place according to the determined parameters and the times of eclipses.
10. A method of scheduling a satellite manoeuvre, the method comprising:
   receiving parameters for one or more planned manoeuvres to move the satellite from a current orbit to a new orbit, wherein the parameters include a time and duration of each of the one or more planned manoeuvres;
   receiving times of eclipses of the Sun by the Earth during future orbits of the satellite; and
   scheduling the manoeuvre to take place according to the determined parameters and the times of eclipses.
11. The method according to clause 10, wherein the received parameters comprise satellite state data, and
   wherein the method further comprises processing the satellite state data, wherein processing the satellite state data comprises:
      receiving the satellite state data in the form of multiple separate files via one or more ground stations; and
      compiling the received satellite state data into a single dataset accessible via an application programming interface and searchable by time range.
12. The method according to clause 11, wherein the satellite state data comprises raw data.
13. The method according to clause 12, wherein processing the satellite state data further comprises:
   filtering the raw satellite state data in an orbit determination process to provide filtered satellite state data, and
   wherein each item of filtered satellite state data corresponds to an item of raw satellite state data.
14. The method according to clause 12 or 13, wherein processing the satellite state data further comprises: receiving manoeuvre data relating to one or more scheduled manoeuvres of the satellite and compiling the received manoeuvre data into a dataset accessible via an application programming interface and searchable by time range.
15. The method according to claim 14 as dependent on claim 13, wherein the manoeuvre data is used in the filtering of the received raw satellite data.
16. The method according to claim 10, wherein the received parameters comprise raw satellite state data and manoeuvre data relating to one or more scheduled manoeuvres of the satellite, and
   wherein the method further comprises processing satellite state data, wherein processing the satellite state data comprises:
      receiving the raw satellite state data;
      receiving the manoeuvre data relating to one or more scheduled manoeuvres of the satellite; and
      filtering the received raw satellite state data in an orbit determination process to provide filtered satellite state data,
      wherein the manoeuvre data is used in the filtering of the received raw satellite state data.
17. The method according to clause 16, wherein processing the satellite state data further comprises: compiling the received raw satellite state data into a single dataset accessible via an application programming interface and searchable by time range, wherein the raw satellite state data is received in the form of multiple separate files via one or more ground states.
18. The method according to any of clauses 3, 7, 13, 17 or any claim dependent thereon, the method further comprising: inserting the filtered satellite state data into the single dataset.
19. The method according to any of clauses 3, 6, 13, 16 or any claim dependent thereon, wherein the filtered satellite state data comprises historical satellite state data, wherein the historical satellite state data is optionally real data associated with one or more historic state vectors of the satellite.
20. The method according to any of clauses 3, 6, 13, 16 or any claim dependent thereon, wherein the filtered satellite state data comprises future satellite state data, wherein the future satellite state data is optionally projected data based on a dynamic model configured to predict future state vectors of the satellite.
21. The method according to any of clauses 1 to 9 or 11 to 20, the method further comprising mapping metadata relating to the satellite to the satellite state data.
22. The method according to clause 21, wherein the metadata comprises one or more of:
   data associated with physical dimensions of the satellite;
   satellite attitude data; and/or
   satellite thrust data comprising information associated with historic and future planned manoeuvres of the satellite.
23. The method according to clause 21 or 22, when dependent on any of clauses 3, 6, 13, 16 or any claim dependent thereon, the method further comprising supplying the metadata for use in the filtering of the raw satellite state data.
24. The method according to any of clauses 4, 6, 14, 16 or any claim dependent thereon, wherein the received manoeuvre data comprises one or more of:
   time of the manoeuvre;
   thrust duration;
   thrust magnitude;
   thrust direction; and/or
   thrust specific impulse
for each of the one or more scheduled manoeuvres.
25. The method according to clause 4, 6, 14, 16 or any claim dependent thereon, wherein the one or more scheduled manoeuvres include one or more future scheduled manoeuvres of the satellite.
26. The method according to clause 25, the method further comprising maintaining a dynamic model of the movement of the satellite wherein the data relating to the one or more future scheduled manoeuvres is used to update the dynamic model.
27. The method according to clause 26 as dependent on any of clauses 3, 6, 13, 16 or any claim dependent thereon, wherein estimates of the state of the satellite obtained from the dynamic model are used in the filtering of the received raw satellite state data.
28. The method according to clause 27, wherein filtering the raw satellite state data is based on different estimates of the state of the satellite, wherein the different estimates include the raw state data and an estimate of the state of the satellite based on a future scheduled manoeuvre.
29. The method according to clause 27 or 28, wherein the estimates of the state of the satellite include estimates of the position of the satellite.
30. The method according to any of clauses 4, 6, 14, 16 or any claim dependent thereon, wherein the one or more scheduled manoeuvres include one or more historic manoeuvres.
31. The method according to clause 30, wherein the manoeuvre data relating to the one or more historic manoeuvres of the satellite comprises measurement data of one or more of:
   time of the manoeuvre,
   thrust duration,
   thrust magnitude,
   thrust direction, and/or
   thrust specific impulse
for each of the one or more historic manoeuvres of the satellite.
32. The method according to clause 31, wherein, after a scheduled manoeuvre was scheduled to be executed, the measurement data is used to determine whether the scheduled manoeuvre was executed.
33. The method according to any of clauses 1 to 9 or 11 to 32, the method further comprising: copying satellite state data that has been received since a previous time interval into a working directory.
34. The method according to any of clauses 1, 7, 11 or any clause dependent thereon, wherein the dataset is stored in a relational database.
35. The method according to any of clauses 1, 7, 11 or any clause dependent thereon, wherein the satellite state data is received as files per pass of the satellite and the data in the dataset is searchable over a time period including multiple passes.
36. The method according to clause 9 or 10 or any clause dependent thereon, wherein scheduling the satellite manoeuvre further comprises: scheduling the time of the manoeuvre to avoid a proportion of the orbit during which the exposure of the satellite to the Sun is maximised.
37. The method according to clause 36, wherein the proportion of the orbit to be avoided is a quarter of the orbit.
38. The method according to clause 9 or 10 or any clause dependent thereon, wherein the duration of at least one of the planned manoeuvres is a period including at least two orbits of the satellite around the Earth.
39. The method according to clause 9 or 10 or any clause dependent thereon, wherein at least one of the planned manoeuvres is a manoeuvre to return the satellite to a predetermined orbit.
40. The method according to clause 9 or 10 or any clause dependent thereon, wherein at least one of the planned manoeuvres is a manoeuvre to avoid a collision.
41. The method according to clause 40, wherein scheduling the satellite manoeuvre further comprises:
   determining candidate parameters for one or more of the planned manoeuvres to move the satellite from a current orbit to a new orbit, wherein the parameters include a candidate time and candidate duration of each of the one or more planned manoeuvres;
   supplying the candidate parameters to a collision avoidance system;
   receiving a respective probability of collision from the collision avoidance system based on each set of candidate parameters;
   if each of the probabilities of collision is above a predetermined threshold, determining new candidate parameters for the one or more planned manoeuvres; and
   repeating the operation of determining candidate parameters for each of the one or more planned manoeuvres until at least one of the respective probabilities of collision is below the predetermined threshold.
42. The method according to clause 9 or 10 or any clause dependent thereon, wherein scheduling the satellite manoeuvre further comprises:
   receiving propulsion scheduling requirements; and
   scheduling the manoeuvre to take place according to the propulsion scheduling requirements.
43. A method of operating a satellite in which manoeuvres of the satellite are scheduled according to the method of clause 9 or 10 or any clause dependent thereon.
44. A method of operating a satellite propulsion system, the method comprising:
   commanding a manoeuvre of the satellite based on manoeuvre data relating to one of one or more future scheduled manoeuvres and based on an assumed relationship between the manoeuvre data relating to the commanded manoeuvre and a change in orbit of the satellite;
   receiving satellite state data associated with the orbit of the satellite after the execution of the commanded manoeuvre according to the command; and
   confirming or updating the assumed relationship based on the received satellite state data,
   wherein the orbit of the satellite is determined in an orbit determination process according to any of clauses 3, 6, 13 or 16 or any clause dependent thereon.
45. A method of processing SAR image data, the method comprising:
   receiving image data acquired during a timespan;
   receiving satellite state data processed according to the method of any of clauses 1, 6, 11, 16 or any clause dependent thereon, wherein the received satellite state data corresponds to a timespan associated with the received image data;
   using the received satellite state data to estimate or determine a geolocation error associated with a position estimate of the satellite;
   if the geolocation error is larger than a predetermined threshold, requesting satellite state data for a larger timespan and repeating the estimation of geolocation error; and
   only passing the image data to a stack for further processing if the geolocation error is below the predetermined threshold.
46. A data processing apparatus comprising a processor configured to perform the method of any preceding clause.
47. A distributed computing system configured to perform the method of any of clauses 1 to 45.
48. A computer-readable medium comprising logic which, when executed by a computer, causes the computer to carry out the method of any of clauses 1 to 45.
49. A computer program comprising instructions which, when executed by a computer, cause the computer to carry out the method of any of clauses 1 to 45.

What is claimed is:

1. A method of scheduling a satellite manoeuvre, the method comprising:
receiving parameters for one or more planned manoeuvres to move the satellite from a current orbit to a new orbit, the parameters including a time and duration of each of the one or more planned manoeuvres;
receiving times of eclipses of the Sun by the Earth during future orbits of the satellite; and
scheduling the manoeuvre to take place according to the determined parameters and the times of eclipses.

2. The method of claim 1, wherein scheduling the satellite manoeuvre further comprises scheduling the item of the manoeuvre to avoid a proportion of the orbit during which the exposure of the satellite to the Sun is maximised.

3. The method of claim 2, wherein the proportion of the orbit to be avoided is a quarter of the orbit and the duration of at least one of the planned manoeuvres is a period including at least two orbits of the satellite around the Earth.

4. (canceled)

5. The method of claim 1, wherein at least one of the planned manoeuvres is a manoeuvre to return the satellite to a predetermined orbit or a manoeuvre to avoid a collision.

6. (canceled)

7. The method of claim 4, wherein scheduling the satellite manoeuvre further comprises:
determining candidate parameters for one or more of the planned manoeuvres to move the satellite from a current orbit to a new orbit, the parameters including a candidate time and candidate duration of each of the one or more planned manoeuvres;
supplying the candidate parameters to a collision avoidance system;
receiving a respective probability of collision from the collision avoidance system based on each set of candidate parameters;
if each of the probabilities of collision is above a predetermined threshold, determining new candidate parameters for the one or more planned manoeuvres; and
repeating the operation of determining candidate parameters for each of the one or more planned manoeuvres until at least one of the respective probabilities of collision is below the predetermined threshold.

8. The method of claim 1, wherein scheduling the satellite manoeuvre further comprises:
receiving propulsion scheduling requirements; and
scheduling the manoeuvre to take place according to the propulsion scheduling requirements.

9. The method according to of claim 1, wherein:
the received parameters comprise satellite state data; and
the method further comprises processing the satellite state data by (a) receiving the satellite state data in the form of multiple separate files via one or more ground stations and (b) compiling the received satellite state data into a single dataset accessible via an application programming interface and searchable by time range.

10. The method of claim 7, wherein:
the satellite state data comprises raw data;
processing the satellite state data further comprises filtering the raw satellite state data in an orbit determination process to provide filtered satellite state data; and
each item of filtered satellite state data corresponds to an item of raw satellite state data.

11. (canceled)

12. The method of claim 8, wherein:
processing the satellite state data further comprises receiving manoeuvre data relating to one or more scheduled manoeuvres of the satellite and compiling the received manoeuvre data into a dataset accessible via an application programming interface and searchable by time range; and
and the manoeuvre data is used in filtering the received raw satellite data.

13. (canceled)

14. The method of claim 1, wherein:
the received parameters comprise raw satellite state data and manoeuvre data relating to one or more scheduled manoeuvres of the satellite; and
the method further comprises processing satellite state data by (a) receiving the raw satellite state data, (b) receiving the manoeuvre data relating to one or more scheduled manoeuvres of the satellite, and (c) filtering the received raw satellite state data in an orbit determination process to provide filtered satellite state data, the manoeuvre data being used in the filtering of the received raw satellite state data.

15. The method of claim 10, wherein:
processing the satellite state data further comprises compiling the received raw satellite state data into a single dataset accessible via an application programming interface and searchable by time range, and
the raw satellite state data is received in the form of multiple separate files via one or more ground states.

16. (canceled)

17. The method of claim 8, wherein:
the filtered satellite state data comprises historical satellite state data, and
the historical satellite state data is real data associated with one or more historic state vectors of the satellite.

18. The method of claim 8, wherein:
the filtered satellite state data comprises future satellite state data, and
the future satellite state data is projected data based on a dynamic model configured to predict future state vectors of the satellite.

19. The method of claim 7, further comprising mapping metadata relating to the satellite to the satellite state data, wherein the metadata comprises one or more of (a) data associated with physical dimensions of the satellite, (b) satellite attitude data, or (c) satellite thrust data comprising information associated with historic and future planned manoeuvres of the satellite.

20. (canceled)

21. The method of claim 14, wherein:
the method further comprises supplying the metadata for use in the filtering of the raw satellite state data; and
for each of the one or more scheduled manoeuvres, the received manoeuvre data comprises one or more of (a) time of the manoeuvre, (b) thrust duration, (c) thrust magnitude, (d) thrust direction, or (e) thrust specific impulse.

22. (canceled)

23. The method of claim 9, wherein:
The one or more scheduled manoeuvres include one or more future scheduled manoeuvres of the satellite;
the method further comprises maintaining a dynamic model of the movement of the satellite; the data relating to the one or more future scheduled manoeuvres is used to update the dynamic model; and
estimates of the state of the satellite obtained from the dynamic model are used in the filtering of the received raw satellite state data.

24. (canceled)

25. (canceled)

26. The method of claim 16, wherein:
filtering the raw satellite state data is based on different estimates of the state of the satellite, and
the different estimates include the raw state data and an estimate of the state of the satellite based on a future scheduled manoeuvre.

27. (canceled)

28. The method of claim 9, wherein:
the one or more scheduled manoeuvres include one or more historic manoeuvres; and
for each of the one or more historic manoeuvres of the satellite, the manoeuvre data relates to the one or more historic manoeuvres of the satellite comprises measurement data of one or more of (a) time of the manoeuvre, (b) thrust duration, (c) thrust magnitude, (d) thrust direction, or (e) thrust specific impulse.

29.-33. (canceled)

34. A satellite operated according to a method of scheduling a satellite manoeuvre, the method comprising:
receiving parameters for one or more planned manoeuvres to move the satellite from a current orbit to a new orbit, wherein the parameters include a time and duration of each of the one or more planned manoeuvres;
receiving times of eclipses of the Sun by the Earth during future orbits of the satellite; and
scheduling the manoeuvre to take place according to the determined parameters and the times of eclipses.

35.-38. (canceled)

39. A non-transitory computer-readable medium comprising computer executable instructions which, when executed by a computer, causes the computer to carry out a method of scheduling a satellite manoeuvre, the method comprising:
receiving parameters for one or more planned manoeuvres to move the satellite from a current orbit to a new orbit, wherein the parameters include a time and duration of each of the one or more planned manoeuvres;
receiving times of eclipses of the Sun by the Earth during future orbits of the satellite; and
scheduling the manoeuvre to take place according to the determined parameters and the times of eclipses.

40. (canceled)
